(19) United States
(12) Patent Application Publication
(10) Pub. No.: US 2008/0014326 A1
(43) Pub. Date: Jan. 17, 2008

(54) METHOD AND SYSTEM FOR PROVIDING BEVERAGE ENHANCEMENT

(76) Inventor: THOMAS J. HANNSZ, HONOLULU, HI (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/457,134

(22) Filed: Jul. 12, 2006

(51) Int. Cl. A23L 2/00

(52) U.S. Cl. 426/590

(57) ABSTRACT

A beverage dispensing device is disclosed herein. The beverage dispensing device can include a beverage container having an aperture for dispensing liquid, a fixed cap, a sliding cap, and a hard candy piece. The fixed cap can be attached to the aperture of the beverage container and be configured to partially permit the passage of the liquid contained in the beverage container. The sliding cap can be fitted on top of the fixed cap. The cap can have a central aperture that can be closed when the sliding cap is pushed against the fixed cap. The central aperture of the sliding cap can be opened when the sliding cap is pulled away from the fixed cap. The hard candy piece can be placed around the sliding cap so as to permit a person drinking from the aperture of the liquid reservoir to simultaneously suckle on the hard candy piece. Furthermore, the hard candy piece can be placed on any other cap configuration of a beverage container.

### RELATED DOCUMENTS

This application makes reference to the Disclosure Document No. 586,174.

### BACKGROUND

1. Field

This disclosure relates generally to dispensing liquid from beverage containers, and more specifically it relates to beverage flavor enhancements devices for beverage containers.

2. General Background

Recreational and nutritional drinks are increasingly consumed. In particular, bottled water has noticeable increased in sale in the past years. Other drinks, such as energy drinks, have also become pervasive in the modern human diet. Many manufacturers and suppliers have developed numerous methods of delivering beverages to consumers. For example, new packaging design and colors, different caps, and a variety of beverage flavors are vehicles always explored to gain new market share. In addition, consumers continue to look for new beverage choices and new drinking experiences.

### SUMMARY

In one aspect, there is a beverage dispensing device that provides beverage enhancement. The beverage dispensing device can include a beverage container and a hard candy piece. The beverage container can have an aperture for dispensing liquid contained in the beverage container. The hard candy piece can be placed at the aperture of the beverage container. The hard candy piece can be placed so as to permit a person drinking from the aperture of the beverage container to simultaneously savor the hard candy.

In a further aspect, the aperture for dispensing the liquid is a spout opening, the hard candy piece being mounted on the spout. The spout can be a sliding spout that slides away from the beverage container to open a passage for the beverage. In addition, the spot can be made of candy. Alternatively, the spout can be coated with candy.

In a further aspect, the hard candy piece can have an annular shape. Furthermore, the hard candy piece can be manufactured to discharge candy syrup, a nutritional supplement, or medicated syrup. In another aspect, the liquid contained in the beverage container is a carbonated drink, an energy drink, a nutritional drink, or a medicinal drink. In addition, the liquid contained in the beverage container can be water, natural fruit juice, milk, or wine.

Additionally, the beverage dispensing device can include a fixed cap and a sliding cap. The fixed cap can be attached to the aperture. The sliding cap can be fitted on top of the fixed cap to open or close a passage for the liquid contained in the beverage container.

In another aspect, there is a beverage dispensing device comprising a beverage container having an aperture for dispensing liquid, a fixed cap, a sliding cap, and a hard candy piece. The fixed cap can be attached to the aperture of the beverage container and be configured to partially permit the passage of the liquid contained in the beverage container. The sliding cap can be fitted on top of the fixed cap. The cap can have a central aperture that can be closed when the sliding cap is pushed against the fixed cap. The central aperture of the sliding cap can be opened when the sliding cap is pulled away from the fixed cap. The hard candy piece can be placed around the sliding cap so as to permit a person drinking from the aperture of the liquid reservoir to simultaneously suckle on the hard candy piece. Other cap configurations that include a hard candy piece to enhance a beverage are also contemplated.

### DRAWINGS

The above-mentioned features and objects of the present disclosure will become more apparent with reference to the following description taken in conjunction with the accompanying drawings wherein like reference numerals denote like elements and in which:

FIG. 1 illustrates a front view of an exemplary cap assembly utilized for beverage enhancement.

FIG. 2 illustrates an exploded view of an exemplary cap assembly utilized for beverage enhancement.

FIG. 3 illustrates an exploded view of an alternative exemplary cap assembly utilized for beverage enhancement.

FIG. 4 illustrates a sectional view of the cap assembly of FIG. 2 taken along line A-A.

FIG. 5 illustrates a sectional view of the cap assembly of FIG. 3 taken along line B-B.

### DETAILED DESCRIPTION

The methods and systems described herein provide beverage enhancing mechanisms. Various beverage food and drug manufacturers produce a multitude of convenience and enjoyment for the consumer. Beverage caps provide convenience and easy to use resealable containers for many environments. Therefore, a flavor-enhancing device is provided herein by attaching a candy piece to the spout of a beverage container for additional flavor and consumer enjoyment. Having a flavored tip that is resealable, allows the consumer to manage his or her use of the flavor-enhancing device. Therefore, the flavor-enhancing device permits a consumer to selectively dispensing the desired amount of flavor. The ease of the device to use, and the compatibility of the device to existing beverage containers allow the device to be utilized for a multitude of beverage products.

In addition, according to the methods and systems disclosed herein a new candy can be accommodated once a consumer has consumed a previous candy installed at during manufacture of the bottle. As such, replacement candy pieces can be provided separately from the beverage container in order to permit a consumer to continue to refill the flavor enhancement to the beverage.

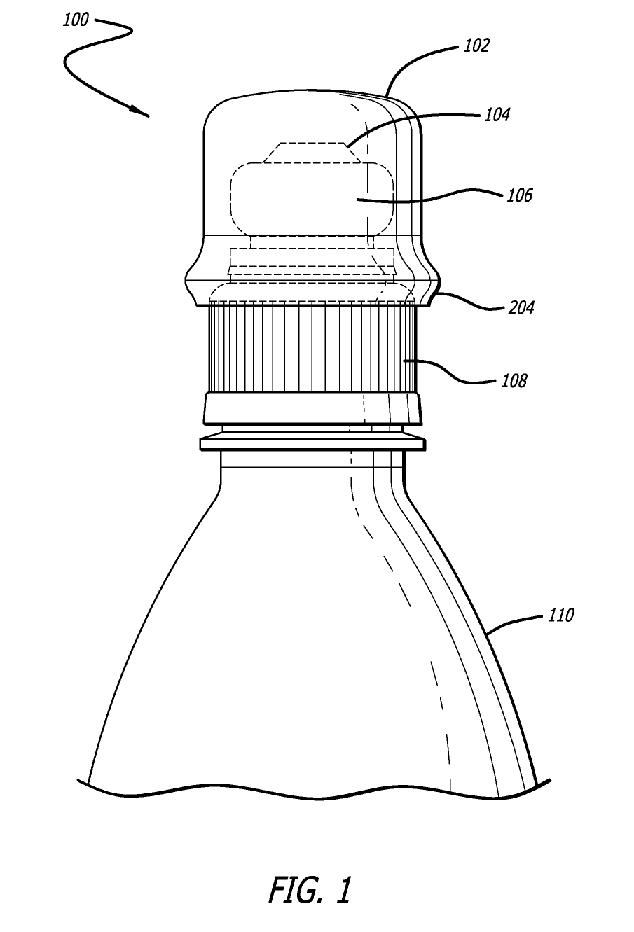

FIG. 1 illustrates a front view of an exemplary cap assembly 100 utilized for beverage enhancement. The cap assembly 100 can include a beverage container 110. In one example, the beverage container 110 is a plastic bottle that contains comestible fluid such as drinking water or juice. In another example, the beverage container 110 can be a reservoir for milk, yogurt, energy drinks, carbonated drinks, alcoholic drinks, medicinal drinks, etc. In addition, the beverage container 110 can have one or more shapes according to manufacturing requirements or distributor requirements. For example, the beverage container 110 can have a conical shape, a spherical shape, a cylindrical shape, a pyramidal shape or any other shape that can be designed for a bottle or a beverage container.

In one embodiment, the cap assembly 100 can include a removable closure member 108 that can be coupled with the beverage container 110 in order to close or partially close the opening of the beverage container 110. In addition, the removable closure member 108 can be coupled with the beverage container 110 utilizing a screw-thread fit or a snap fit. In one example, if the removable closure member 108 couples with the beverage container 110 with a screw-thread, the removable closure member 108 can include internal threads that can be configured to fit with external threads at the end of the neck of the beverage container 110. The spout 104 can be configured to have a spindle shape such that a narrower cylinder is configured towards the center of the body of the spindle and an annular edge is configured at each of the ends of the spindle so as to permit the mounting of an annular object on the spindle. Thus the spout 104 can accommodate the mounting of a hard candy piece that can be placed around the neck of the spout, such that a consumer drinking from the end of the spout 104 can simultaneously taste the hard candy mounted on the body of the spout and the beverage pour out of the spout 104.

In one embodiment, the spout is an extension of the removable closure member 108 such that the spout and the removable closure member 108 are one single piece. Once the removable closure member 108 is screwed on the neck of the bottle, the spout does not move or slide. The spout 104 can be removed together with the removable closure member 108 when a consumer unscrews the removable closure member 108 from the beverage container 110. As such, the candy piece can be fixed to the spout of the removable closure member 108. In another embodiment, the candy piece can be mounted on the spout of any beverage container or bottle. In yet another embodiment, the candy piece can be attached next to any opening of the beverage container or bottle.

In another embodiment, the spout 104 can be a sliding spout that can be pulled upwards and away from removable closure member 108 such that an opening can be formed for the beverage or liquid to be dispensed through the spout 104. In one example, if the spout 104 is configured to be sliding upwards and downwards along the central axis of the beverage container 110, the spout can have an internal ridge that can permit to stop the sliding spout when a consumer slides the spout 104 upwards. Likewise, the spout can be configured to be mounted on the removable closure member 108 such that when the body of the spout tightly fits the removable closure member 108 in order prevent any liquid to be released from the beverage container 110.

In addition, a sealing cap can be added to protect the candy piece 106 and the spout 104 from contact with any unclean or unhealthy entity before the product or beverage is sold to the first consumer. For example, sealing cap 102 can be manufactured to cover the candy piece 106 and the spout 104 until a consumer breaks away the sealing cap 102 from a ring that is fixed to the beverage container 110 or to the removable closure member 108. Thus, the sealing cap 102 can be manufactured with a weakening line to allow the daring removal of the sealing cap 102 away from the beverage container 110.

The removable closure member 108 can be adapted to fit any industry standard bottle. In one embodiment, the removable closure member 108 can be designed to fit on a bottle having a neck diameter of twenty eight millimeters. In another embodiment, the removable closure member 108 can be designed to fit a neck bottle of thirty eight millimeters.

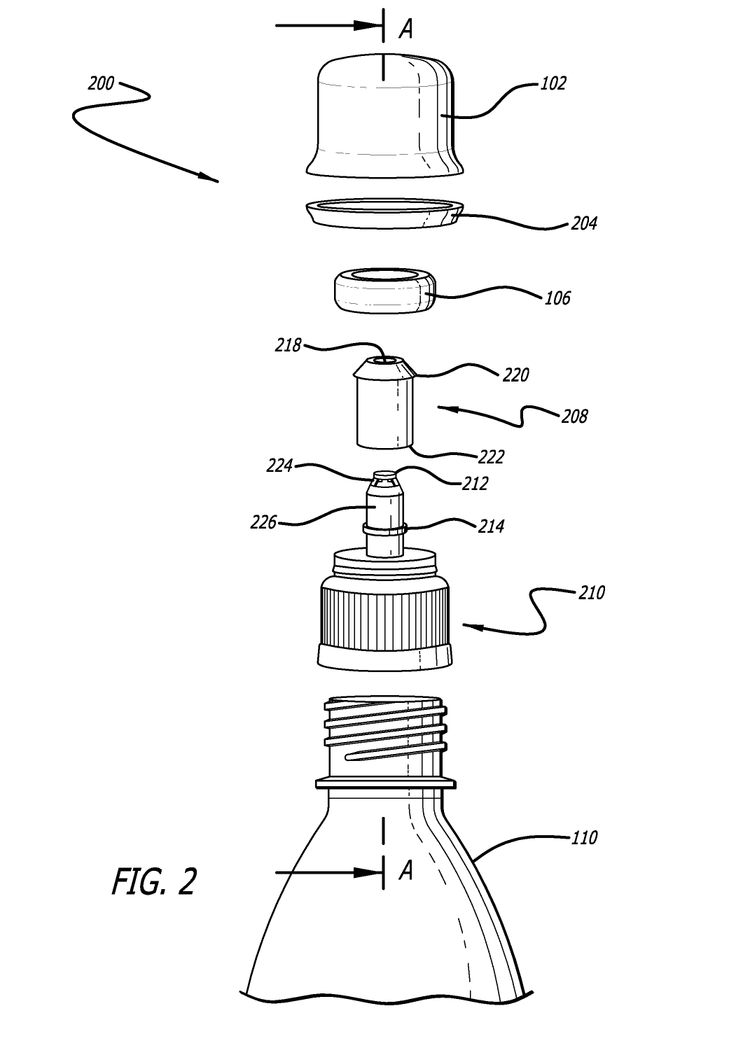

FIG. 2 illustrates an exploded view of an exemplary cap assembly utilized for beverage enhancement. The cap assembly 200 is one of various exemplary cap assemblies that can be adapted with a candy piece for beverage enhancement. The beverage cap assembly 200 can include the sealing cap 102 and a break-away ring 204 which are initially attached during manufacturing. The sealing cap 102 and a break-away ring 204 can be configured to be joined together separated upon a consumer breaking away the sealing cap 102 from the ring 204.

In addition, the sealing cap 102 can include a lower edge around the circumference of the clear cap to firmly fit against the body of the beverage container 110. In one example, the sealing cap 102 can be transparent thereby permitting a consumer to view the candy piece. In another embodiment, the sealing cap 102 can be translucent or colored. Likewise, the sealing cap 102 can further have different shapes as designed by the manufacturer or supplier of the beverage. For example the sealing cap 102 can have a bulbous shape that would give the impression of a light bulb shape. In another example, the sealing cap 102 can have a cylindrical shape.

The cap assembly 200 can further include an candy piece 106. The candy piece can be an integral part of the cap assembly, or an add-on to a member of the cap assembly. For example, the candy piece can be the spout of the cap assembly. In another example, the candy piece can be a coating on a member of the cap assembly 200.

The candy piece 106 can be, for example, of annular shape and perfectly round. The candy piece 106 can be manufactured to fit on a sliding cap 208 configured to accommodate the fitting of an annular candy piece. In addition, the candy piece 106 can vary is size, texture, shape, scale, solubility, flavor, color or design.

In addition, the candy piece 106 can also be utilized to enhance the beverage in one or more ways. For example, the candy piece can, in addition, contain medication to be administered to a consumer. In another example, the candy piece 106 can include nutritional supplements to be administered to the consumer. In another example, the candy piece simply provides flavor to be combined with the beverage stored in the beverage container 110.

The cap assembly 200 can further include a sliding cap 208. The sliding cap 208 can be configured with a central aperture 218 that permits the beverage or liquid to be dispensed from the beverage container 110. The sliding cap 208 can also be configured to have a spindle shape in order to permit the fitting of the candy piece 106 around the body of the spindle shape of the sliding cap 208. As such, the sliding cap 208 can be configured with an upper edge 220 and a lower edge 222 so as to prevent the upwards or downwards sliding of the candy piece 106.

In addition, the cap assembly 200 can further include a fixed cap 210. The fixed cap 210 can be configured with internal threading in order to couple with the beverage container 110 so as to partially close the beverage container 110. Furthermore, the fixed cap 210 can include a central protrusion 226 that can be inserted in the concave portion of the sliding cap 208, and fit tightly in order to close the passage of liquids out of the beverage container 110. As such, the central protrusion 226 can be covered by the sliding cap 208 upon a consumer pressing the sliding cap downwards towards the beverage container 110. The sliding cap 208 would have a sliding range that permits sliding cap 208 to move upwards and downwards to either open the passage or close the passage of liquid from the beverage container 110. In one embodiment, the downwards sliding range of the sliding cap 208 reaches a limit upon the lower edge 222 of the sliding cap 208 touching the lower body of the fixed cap 210. In addition, the upper limit sliding range of the sliding cap 208 reaches a stop upon the sliding cap 208 being stopped by a stop ridge 214 configured around the central protrusion 226. The sliding cap 208 can be configured with an internal ridge that is configured on the internal walls of the sliding cap 208. In one example, the internal ridge can be near the bottom edge 222. Thus, the internal ridge of the sliding cap 208 can operate as a stop upon encountering the stop ridge 214 when the consumer pulls the sliding cap 208 upwards. As the sliding cap 208 is moved upwards and downwards, the candy piece 106 mounted on the sliding cap 208 can move together with the sliding cap 208.

In one example, because the candy piece 106 is configured to be around the sliding cap 208, the consumer can utilize the candy piece 106 to pull the sliding cap 208 upwards. Thus, for example, a consumer can utilize the consumer's teeth to secure the candy piece 106 and pull away from the beverage container 110 in order to cause the sliding cap 208 to move upwards and thereby open the passage of liquid outside of the beverage container 110. In another example, the consumer can utilize the consumer's fingers, or any other tool, to grab the candy piece 106 and pull away from the beverage so as to cause the sliding cap 208 to move upwards and open the passage of liquid outside the beverage container 110.

Furthermore, the central protrusion 226 can also include a sealing knob 212 that is suspended at the center of the central protrusion 226 and supported by support members 224. In one example, there can be two support members 224 supporting the sealing knob 212 in the middle of the central protrusion 226. In another example, there can be three support members 224 to support the sealing knob 212. Any number of support members can be utilized in order to support the sealing knob 212 as long as an opening in between support members 224 can be formed such that the liquid can filtrate through said opening and into the central aperture 218 for dispensing liquid beverage from the beverage container 110.

As previously mentioned, as the liquid or beverage is dispensed through the central aperture 218 the beverage or liquid can be simultaneously released into the consumer's mouth as well as flavors or any other substances dispensed through the candy piece 106. The sealing knob 212 can mate with the central aperture 218 to hermetically seal the passage of liquid outside of the beverage 110. On the other hand, upon the sliding cap 208 upwards, the sealing knob 212 can be decoupled and disconnected from central aperture 218 creating a passage for the beverage to be released. As previously mentioned, the candy piece 106 can permit a consumer to consume the contents of the candy piece simultaneously with the contents of the beverage container 110 as the beverage pours out through the central aperture 218.

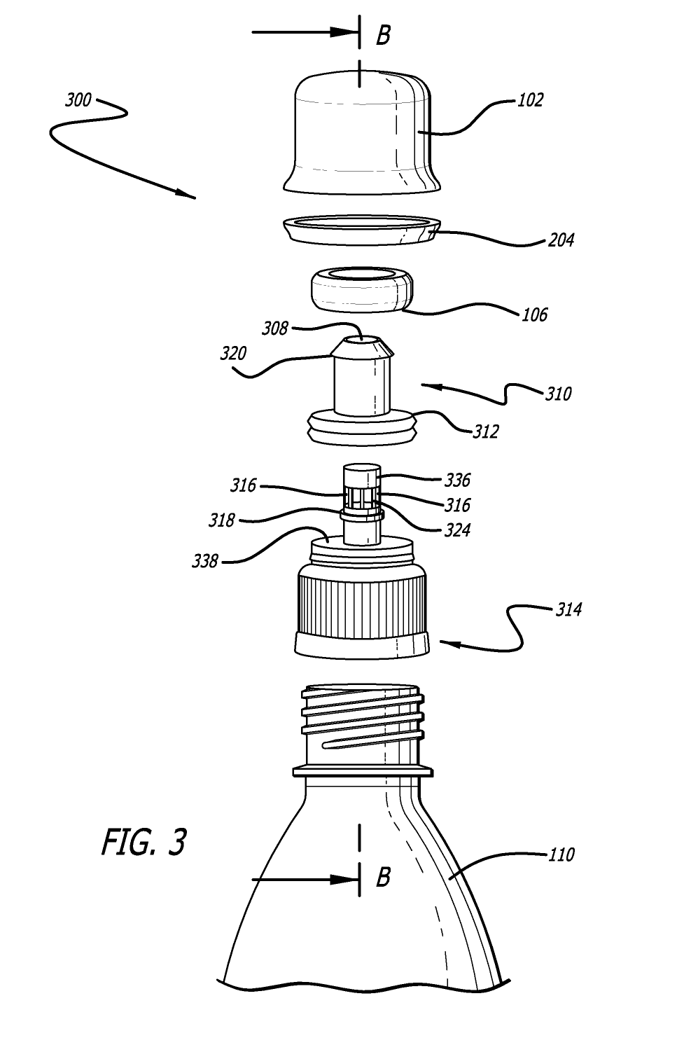

FIG. 3 illustrates an exploded view of an alternative exemplary cap assembly utilized for beverage enhancement. As previously discussed, it should be understood that cap assembly 300 is simply an exemplary cap assembly that can be used to deliver beverages as disclosed herein. Other cap assemblies can also be utilized to provide flavor enhancement as discussed herein.

Cap assembly 300 can include the sealing cap 102 and the safety ring 204 to insure proper sealing of the beverage container 110 before the beverage is distributed to a consumer. In addition, the cap assembly 300 can also include a candy piece 106 that can be mounted on one or more structures of the cap assembly 300 in order to provide beverage flavor enhancement. Again, the candy piece 106 can have another shape with a hollow center that permits the candy piece 106 to be fitted on a sliding cap 310. The sliding cap 310 can be provided as part of the cap assembly 300 in order to permit a consumer to slide the sliding cap 310 upwards or downwards so as to either open or close a passage for delivery of the beverage contained in the beverage container 110. The sliding cap 310 can be configured to mate with the fixed cap 314 to provide a mechanism for beverage delivery. As such, the sliding cap 310 can operate as a spout through which the beverage can be dispensed. Furthermore, the sliding cap 310 can include a central aperture 308 through which the beverage can be dispensed.

The sliding cap 310 can further be configured to have a spindle-like shape such that the candy piece 106 mounted on the sliding cap 310 can be secured around the sliding cap 310 and not slide upwards or downwards. For example, the sliding cap 310 can include an upper edge 320 and a bottom edge 312 that can act as an upper and a lower stop mechanisms that prevent the candy piece from sliding away from the sliding cap 310.

In addition, the sliding cap 310 can further include one or more ridges around the periphery of the bottom edge 312 in order to provide a consumer a gripping mechanism for sliding the sliding cap 310. Thus, the ridges around the periphery of the bottom edge 312 permits a consumer to avoid contact with the candy piece 106 and only touch the bottom edge 312 in order to slide the sliding cap 310 upwards or downwards.

In another example, the bottom edge 312 can further be utilized by the consumer to push the sliding cap 310 downwards. The cap assembly 310 can further include a fixed cap 314 that can be attached through various mechanisms to the beverage container 110. As previously discussed, the fixed cap 314 can include a spiral thread that can be coupled with an external spiral thread of the beverage container 110 neck. In another embodiment, the fixed cap can be coupled with the beverage container 110 utilizing a snap fit.

The fixed cap 314 can further include a central protrusion 336 upon which the sliding cap 310 can be fitted. Therefore, the central protrusion can be configured to fit with the concave portion of the sliding cap 310 in a male-female coupling. Furthermore, the central protrusion 336 can include a cylindrical opening 316 that permits the beverage or liquid stored in the beverage container 110 to pass through. The central protrusion 236 can also include a stop ridge 318 around the central protrusion 336 that permits a snap fit of the sliding cap 310 and further to operate as a stopping mechanism to prevent the sliding cap 310 to be decoupled away from the fixed cap 314.

The sliding cap 310 can be operated to hermetically seal the beverage container 110 such that no liquid can flow outside of the beverage container 110. Thus, for example, a consumer can press the sliding cap 310 towards the beverage container so as to obtain a snug fit of the upper body of the central protrusion 336 and the central aperture 308. Upon a consumer sliding the sliding cap 310 upwards the body of the protrusion 336 and the central aperture 308 can be decoupled so as to form an opening through which the beverage can flow. Thus, the liquid beverage can flow through opening 316, and out through the central aperture 308.

The cylindrical opening 316 can be configured to be supported by one or more supporting members 324. Any number of supporting members can be utilized as long as one or more openings are formed in between each of the support members such that the liquid or the beverage can flow through.

As previously discussed, the range of movement of the sliding cap 310 can have a lower limit of motion at the lower body 338 of the fixed cap 314. In addition, the sliding cap 310 can have an upper limit of motion at an internal ridge of the sliding cap 310 that stops the upwards movement of the sliding cap 310 when the internal ridge makes contact with the ridge 324 of the central protrusion 336.

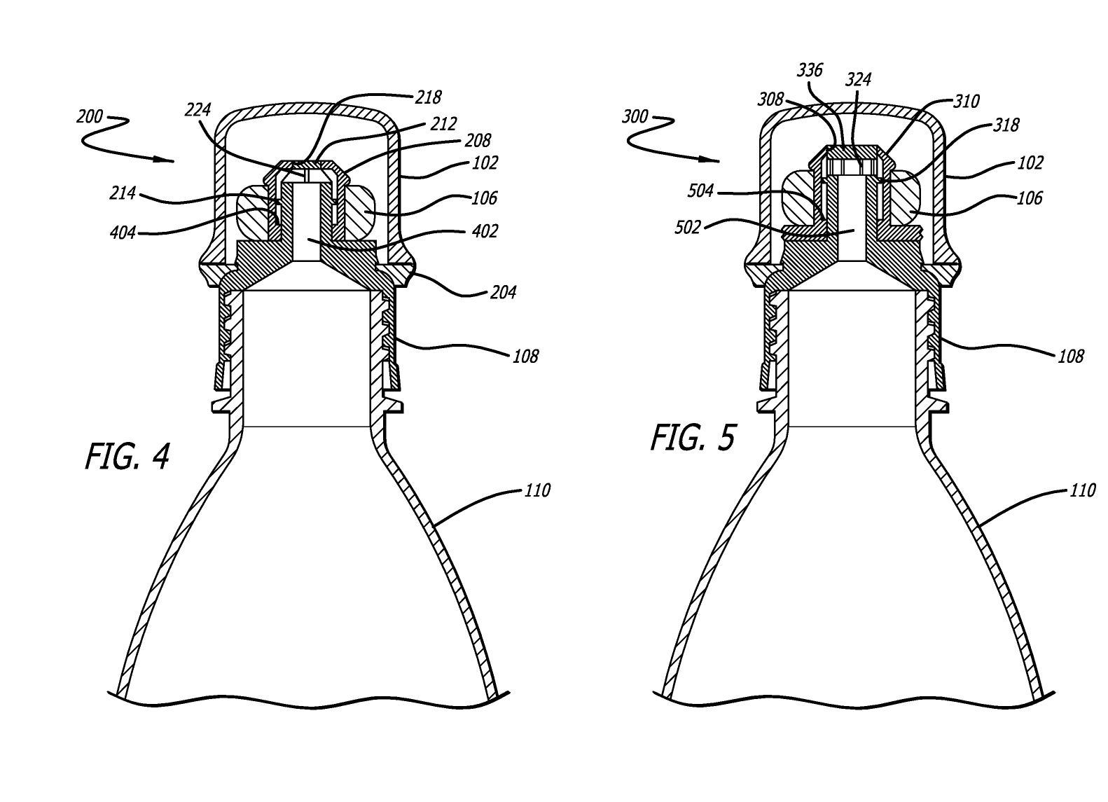

FIG. 4 illustrates a sectional view of the cap assembly of FIG. 2 taken along line A-A. In one example, the cap assembly 200 includes the sealing cap 102. The sealing cap 102 can be attached to the beverage container 110 before the beverage container 110 has been opened. In another embodiment, the sealing cap 102 can be coupled with safety ring 204. The sealing cap 102 can be configured so that the cap does not touch the candy piece 106 mounted on the sliding cap 208. In addition to sealing cap 102, another embodiment can be configured to have contact with the sliding cap 208 such that when a consumer releases or pulls the sealing cap 102 in order to break away the cap 102 from the beverage container 110, the sliding cap 208 is also pulled away in order to permit the liquid beverage in the beverage container 110 to flow through the central aperture 218.

The liquid can be dispensed when the sliding cap 208 is pulled upwards. Upon the cap 208 being pulled upwards, the internal ridge 404 can come in contact with the stopping ridge 214 so as to prevent the sliding cap 208 to move any further. The liquid contained in the beverage container 110 can then flow through the channel 402, through the openings formed in between supporting members 224, and out through the central aperture 218 for dispensing to the consumer. As the fluid travels through the aperture 218, the consumer consuming the beverage being dispensed through the central aperture 218 can simultaneously suck on the candy piece 106.

FIG. 5 illustrates a sectional view of the cap assembly of FIG. 3 taken along line B-B. The cap assembly 300 permits the beverage or liquid to flow through the channel 502 and to be dispensed to a consumer upon the consumer sliding the sliding cap 310 upwards. Once the consumer slides the sliding cap 310 away from the beverage container 110, the beverage or liquid contained in the beverage container 110 can flow through the channel 502, through the openings between support members 324, and out through the central aperture 308. Again, this configuration of a cap assembly can also be used to integrate a candy piece 106 around the spindle shape of the sliding cap 310. The cap assembly 300 also illustrates an internal ridge 504 that can be configured and manufactured as part of sliding cap 310. The internal ridge 504 protrudes inwardly towards the channel 502 so as to make contact with the stopping ridge 318 to prevent the sliding cap 310 to slide away completely from the beverage container 110 when pulled away from the beverage container 110. Again, the consumer drinking from the central aperture 308 can simultaneously enjoy the flavor of the candy piece 106 including any content that is administered or delivered through the candy piece 106.

It must be understood by one skilled in the art that the examples provided for the embodiments as illustrated in FIG. 4 and FIG. 5 are simply exemplary cap assemblies for delivering a beverage and do not represent all the variations that may exist upon which a candy piece can be applied to enhance the beverage flavor.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A beverage dispensing device, comprising:
a beverage container having an aperture for dispensing liquid contained in the beverage container; and
a hard candy piece placed at the aperture of the beverage container, the hard candy piece placed so as to permit a person drinking from the aperture of the beverage container to simultaneously savor the hard candy.

2. The beverage dispensing device of claim 1, wherein the aperture for dispensing liquid is a spout opening, the hard candy piece being mounted on the spout.

3. The beverage dispensing device of claim 2, wherein the spout is a sliding spout that slides away from the beverage container to open a passage for the beverage.

4. The beverage dispensing device of claim 2, wherein the spout is made of candy.

5. The beverage dispensing device of claim 2, wherein the spout is coated with candy.

6. The beverage dispensing device of claim 1, wherein the hard candy piece has an annular shape.

7. The beverage dispensing device of claim 1, wherein the hard candy piece is manufactured to discharge candy syrup.

8. The beverage dispensing device of claim 1, wherein the hard candy piece is manufactured to discharge a nutritional supplement.

9. The beverage dispensing device of claim 1, wherein the hard candy piece is manufactured to discharge medicated syrup.

10. The beverage dispensing device of claim 1, wherein the liquid contained in the beverage container is a carbonated drink, an energy drink, a nutritional drink, or a medicinal drink.

11. The beverage dispensing device of claim 1, wherein the liquid contained in the beverage container is water, natural fruit juice, milk, or wine.

12. The beverage dispensing device of claim 1, further comprising a fixed cap and a sliding cap, the fixed cap being attached to the aperture, wherein the sliding cap is fitted on top of the fixed cap to open or close a passage for the liquid contained in the beverage container.

13. A beverage dispensing device, comprising:
a beverage container having an aperture for dispensing liquid;
a fixed cap that is attached to the aperture of the beverage container, the fixed cap configured to partially permit the passage of the liquid contained in the beverage container;
a sliding cap that is fitted on top of the fixed cap, the sliding cap having a central aperture that is closed when the sliding cap is pushed against the fixed cap, the central aperture of the sliding cap being opened when the sliding cap is pulled away from the fixed cap; and
a hard candy piece placed around the sliding cap so as to permit a person drinking from the aperture of the liquid reservoir to simultaneously suckle on the hard candy piece.

14. The beverage dispensing device of claim 13, wherein the hard candy piece has an annular shape.

15. The beverage dispensing device of claim 13, wherein the hard candy piece is manufactured to discharge candy syrup.

16. The beverage dispensing device of claim 13, wherein the hard candy piece is manufactured to discharge a nutritional supplement.

17. The beverage dispensing device of claim 13, wherein the hard candy piece is manufactured to discharge medicated syrup.

18. The beverage dispensing device of claim 13, wherein the liquid contained in the beverage container is a carbonated drink, an energy drink, a nutritional drink, or a medicinal drink.

19. The beverage dispensing device of claim 13, wherein the liquid contained in the beverage container is water, natural fruit juice, milk, or wine.
